(19) United States
(12) Patent Application Publication
(10) Pub. No.: US 2013/0149640 A1
(43) Pub. Date: Jun. 13, 2013

(54) TONER PARTICLE, DEVELOPER, AND IMAGE FORMING METHOD

(71) Applicant: Masayuki ISHII, Shizuoka (JP)

(72) Inventor: Masayuki ISHII, Shizuoka (JP)

(21) Appl. No.: 13/677,575

(22) Filed: Nov. 15, 2012

(30) Foreign Application Priority Data
Dec. 7, 2011 (JP) 2011-267501

(51) Int. Cl. G03G 9/093; G03G 13/20

(52) U.S. Cl. CPC G03G 9/09357; G03G 13/20
USPC 430/108.3; 430/124.3; 430/108.7

(57) ABSTRACT

A toner particle including a mother particle and an outer shell layer is provided. The mother particle includes a binder resin and a colorant. The outer shell layer is formed of a reaction product of a silicon compound chemically binding to a surface of the mother particle. The outer shell layer may be formed on either the whole surface or a part of the surface of the mother particle. The reaction product of the silicon compound may be a silica compound.

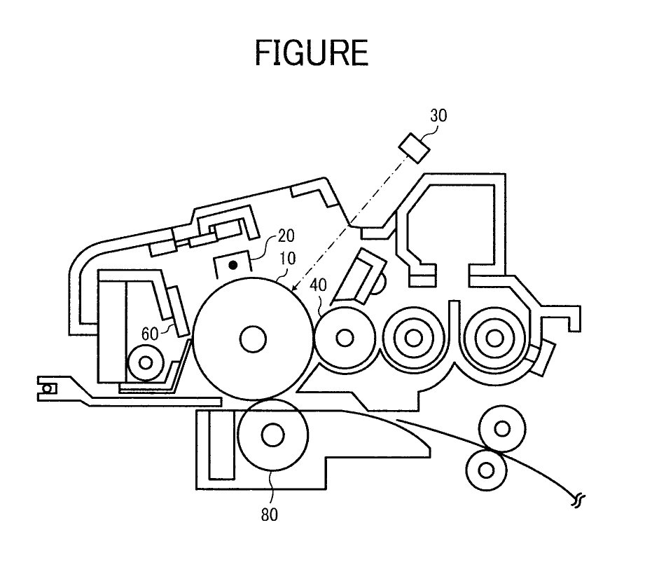

### CROSS-REFERENCE TO RELATED APPLICATIONS

This patent application is based on and claims priority pursuant to 35 U.S.C. §119 to Japanese Patent Application No. 2011-267501, filed on Dec. 7, 2011, in the Japan Patent Office, the entire disclosure of which is hereby incorporated by reference herein.

### BACKGROUND

1. Technical Field

The present disclosure relates to a toner particle, a developer, and an image forming method.

2. Description of Related Art

Typical toner particles include fine particulate materials having a particle diameter of several to several tens nanometers at their surfaces. Fine particulate materials present at or covering the surfaces of toner particles are hereinafter referred to as “external additives”. For example, JP-2001-066820-A discloses a particulate material (e.g., silica) having a large particle diameter as an external additive. As another example, hydrophobized silica and metal oxides have been proposed as external additives. They generally impart fluidity, chargeability, environmental stability to toner particles.

Various techniques have been proposed for covering the surfaces of toner particles with functional fine particulate materials to improve their surface properties. At the same time, various attempts have been made for preventing external additives from being embedded in or releasing from toner particles.

If external additives are embedded in or release from toner particles, surface properties as well as physical properties, such as chargeability, fluidity, and cohesion, of the toner particles are changed, which may results in deterioration of image quality.

### SUMMARY

In accordance with some embodiments, a toner particle including a mother particle and an outer shell layer is provided. The mother particle includes a binder resin and a colorant. The outer shell layer is formed of a reaction product of a silicon compound chemically binding to a surface of the mother particle. The outer shell layer may be formed on either the whole surface or a part of the surface of the mother particle.

In accordance with some embodiments, the reaction product of the silicon compound is a silica compound.

### BRIEF DESCRIPTION OF THE DRAWINGS

A more complete appreciation of the disclosure and many of the attendant advantages thereof will be readily obtained as the same becomes better understood by reference to the following detailed description when considered in connection with the accompanying drawings, wherein:

FIGURE is a schematic view of a process cartridge according to an embodiment

### DETAILED DESCRIPTION

Embodiments of the present invention are described in detail below with reference to accompanying drawings. In describing embodiments illustrated in the drawings, specific terminology is employed for the sake of clarity. However, the disclosure of this patent specification is not intended to be limited to the specific terminology so selected, and it is to be understood that each specific element includes all technical equivalents that operate in a similar manner and achieve a similar result.

For the sake of simplicity, the same reference number will be given to identical constituent elements such as parts and materials having the same functions and redundant descriptions thereof omitted unless otherwise stated.

In accordance with some embodiments, a toner particle including a mother particle and an outer shell layer is provided. The mother particle includes a binder resin and a colorant. The outer shell layer is formed of a reaction product of a silicon compound chemically binding to a surface of the mother particle. The outer shell layer may be formed on either the whole surface or a part of the surface of the mother particle.

The outer shell layer is directly binding to the surface of the mother particle by chemical bonds, such as covalent bonds, that have strong binding forces. Unlike typical external additives, the outer shell layer does not likely to transfer or release from the mother particle even when receives external stress. Thus, the outer shell layer is able to reliably cover the surface of the mother particle and to impart improved durability, environmental stability, and hydrophobicity to the mother particle for an extended period of time.

According to some embodiments, the toner particle further includes one or more kinds of external additives on the outer shell layer. Usable external additives are not limited to specific materials.

In accordance with some embodiments, a developer is also provided. The developer includes the above-described toner particle. When used for electrophotography, the developer provides a good combination of cleanability, durability, and high image quality.

In accordance with some embodiments, a developer container is also provided. The developer container includes a container filled with the above-described developer. When used for electrophotography, the developer container provides a good combination of cleanability, durability, and high image quality.

The toner particle according to an embodiment may be contained in a process cartridge including an image bearing member and a developing device that develops an electrostatic latent image formed on the image bearing member into a toner image that is visible. The process cartridge is detachably attachable to image forming apparatuses and can be handled with ease. The process cartridge containing the toner provides a good combination of cleanability, durability, and high image quality.

The toner particle according to an embodiment may be also contained in an image forming apparatus including an image bearing member, an electrostatic latent image forming device, a developing device, a transfer device, and a fixing device. The electrostatic latent image forming device forms an electrostatic latent image on the image bearing member. The developing device develops the electrostatic latent image into a toner image that is visible with the toner particle. The transfer device transfers the toner image onto an image support. The fixing device fixes the toner image on the image support. The image forming apparatus provides a good combination of cleanability, durability, and high image quality.

In accordance with some embodiments, an image forming method is provided. The image forming method includes the processes of charging an image bearing member, developing an electrostatic latent image formed on the image bearing member into a toner image, transferring the toner image onto an image support, and fixing the toner image on the image support.

In the process of charging the image bearing member, for example, a charger supplies a voltage to a surface of the image bearing member so that the surface of the image bearing member is uniformly charged. An irradiator then irradiates the image bearing member with light containing image information so that an electrostatic latent image is formed on the image bearing member. In the process of developing, the electrostatic latent image is developed into a toner image that is visible with the developer according to an embodiment. In the process of transferring, the toner image is transferred onto the image support. In the process of fixing, the toner image is fixed on the image support. The image forming method provides a good combination of cleanability, durability, and high image quality.

The toner particle according to an embodiment has the outer shell layer formed of a reaction product of a silicon compound chemically binding to a surface of the mother particle. Combination of the outer shell layer and external additives are more effective. The mother particle can be prepared by, for example, pulverization, polymerization, or supercritical methods.

Specific examples of usable binder resins include, but are not limited to, homopolymers of styrene or styrene derivatives (e.g., polystyrene, polyp-chlorostyrene), polyvinyl toluene), styrene-based copolymers (e.g., styrene-p-chlorostyrene copolymer, styrene-propylene copolymer, styrene-vinyltoluene copolymer, styrene-methyl acrylate copolymer, styrene-ethyl acrylate copolymer, styrene-methacrylic acid copolymer, styrene-methyl methacrylate copolymer, styrene-ethyl methacrylate copolymer, styrene-butyl methacrylate copolymer, styrene-methyl α-chloromethacrylate copolymer, styrene-acrylonitrile copolymer, styrene-vinyl methyl ether copolymer, styrene-vinyl methyl ketone copolymer, styrene-butadiene copolymer, styrene-isoprene copolymer, styrene-maleate copolymer), polymethyl methacrylate, polybutyl methacrylate, polyvinyl chloride, polyvinyl acetate, polyethylene, polyester, polyurethane, epoxy resin, polyvinyl butyral, polyacrylic acid, rosin, modified rosin, terpene resin, phenol resin, aliphatic or aromatic hydrocarbon resin, and aromatic petroleum resin. Two or more of these resins can be used in combination.

Specific examples of usable colorants include, but are not limited to, carbon black, Nigrosine dyes, black iron oxide, NAPHTHOL YELLOW S, HANSA YELLOW (10G, 5G and G), Cadmium Yellow, yellow iron oxide, loess, chrome yellow, Titan Yellow, polyazo yellow, Oil Yellow, HANSA YELLOW (GR, A, RN and R), Pigment Yellow L, BENZIDINE YELLOW (G and GR), PERMANENT YELLOW (NCG), VULCAN FAST YELLOW (5G and R), Tartrazine Lake, Quinoline Yellow Lake, ANTHRAZANE YELLOW BGL, isoindolinone yellow, red iron oxide, red lead, orange lead, cadmium red, cadmium mercury red, antimony orange, Permanent Red 4R, Para Red, Fire Red, p-chloro-o-nitroaniline red, Lithol Fast Scarlet G, Brilliant Fast Scarlet, Brilliant Carmine BS, PERMANENT RED (F2R, F4R, FRL, FRLL and F4RH), Fast Scarlet VD, VULCAN FAST RUBINE B, Brilliant Scarlet G, LITHOL RUBINE GX, Permanent Red FSR, Brilliant Carmine 6B, Pigment Scarlet 3B, Bordeaux 5B, Toluidine Maroon, PERMANENT BORDEAUX F2K, HELIO BORDEAUX BL, Bordeaux 10B, BON MAROON LIGHT, BON MAROON MEDIUM, Eosin Lake, Rhodamine Lake B, Rhodamine Lake Y, Alizarine Lake, Thioindigo Red B, Thioindigo Maroon, Oil Red, Quinacridone Red, Pyrazolone Red, polyazo red, Chrome Vermilion, Benzidine Orange, perynone orange, Oil Orange, cobalt blue, cerulean blue, Alkali Blue Lake, Peacock Blue Lake, Victoria Blue Lake, metal-free Phthalocyanine Blue, Phthalocyanine Blue, Fast Sky Blue, INDANTHRENE BLUE (RS and BC), Indigo, ultramarine, Prussian blue, Anthraquinone Blue, Fast Violet B, Methyl Violet Lake, cobalt violet, manganese violet, dioxane violet, Anthraquinone Violet, Chrome Green, zinc green, chromium oxide, viridian, emerald green, Pigment Green B, Naphthol Green B, Green Gold, Acid Green Lake, Malachite Green Lake, Phthalocyanine Green, Anthraquinone Green, titanium oxide, zinc oxide, and lithopone. Two or more of these colorants can be used in combination.

In some embodiments, the content of the colorant in the mother particle is 1 to 15% by weight or 3 to 10% by weight.

The colorant can be combined with a resin to be used as a master batch. Specific examples of usable resins for the master batch include, but are not limited to, homopolymers of styrene or styrene derivatives, styrene-based copolymers, polymethyl methacrylate, polybutyl methacrylate, polyvinyl chloride, polyvinyl acetate, polyethylene, polypropylene, polyester, epoxy resin, epoxy polyol resin, polyurethane, polyamide, polyvinyl butyral, polyacrylic acid, rosin, modified rosin, terpene resin, aliphatic or alicyclic hydrocarbon resin, aromatic petroleum resin, chlorinated paraffin, and paraffin wax. Two or more of these resins can be used in combination.

The mother particle may further include a release agent. In some embodiments, the content of the release agent in the mother particle is 1 to 40% by weight or 3 to 30% by weight. When the content of the release agent is greater than 40% by weight, fluidity of the toner may be poor.

The mother particle may further include a charge controlling agent. The charge controlling agent may be either negative or positive.

Specific examples of usable negative charge controlling agents include, but are not limited to, resins and compounds having an electron-donating functional group, azo dyes, and metal complexes of organic acids. Specific examples of commercially available negative charge controlling agents include, but are not limited to, BONTRON® S-31, S-32, S-34, S-36, S-37, S-39, S-40, S-44, E-81, E-82, E-84, E-86, E-88, A, 1-A, 2-A, and 3-A (from Orient Chemical Industries Co., Ltd.); KAYACHARGE N-1 and N-2 and KAYASET BLACK T-2 and 004 (from Nippon Kayaku Co., Ltd.); AIZEN SPILON BLACK T-37, T-77, T-95, TRH, and TNS-2 (from Hodogaya Chemical Co., Ltd.); and FCA-1001-N, FCA-1001-NB, and FCA-1001-NZ (from Fujikura Kasei Co., Ltd.). Two or more of these materials can be used in combination.

Specific examples of usable positive charge controlling agents include, but are not limited to, basic compounds such as nigrosine dyes, cationic compounds such as quaternary ammonium salts, and metal salts of higher fatty acids. Specific examples of commercially available positive charge controlling agents include, but are not limited to, BONTRON® N-01, N-02, N-03, N-04, N-05, N-07, N-09, N-10, N-11, N-13, P-51, P-52, and AFP-B (from Orient Chemical Industries Co., Ltd.); TP-302, TP-415, and TP-4040 (from Hodogaya Chemical Co., Ltd.); COPY BLUE® PR and COPY CHARGE® PX-VP-435 and NX-VP-434 (from Hoechst AG); FCA 201, 201-B-1, 201-B-2, 201-B-3, 201-PB, 201-PZ, and 301 (from Fujikura Kasei Co., Ltd.); and PLZ 1001, 2001, 6001, and 7001 (from Shikoku Chemicals Corporation). Two or more of these materials can be used in combination.

In some embodiments, the content of the charge controlling agent is 0.1 to 10% by weight or 0.2 to 5% by weight, based on 100% by weight of the binder resin. When the content of the charge controlling agent is greater than 10% by weight, the toner may be too excessively charged to be electrostatically attracted to a developing roller, resulting in deterioration of fluidity and image density. When the content of the charge controlling agent is less than 1% by weight, the toner may not be quickly or sufficiently charged, resulting in poor image quality.

The mother particle may be produced by any methods, such as pulverization methods, emulsion polymerization methods, suspension polymerization methods, and polymer suspension methods.

A typical pulverization method is described in detail below. First, a mixture of raw materials of the mother particle is melt-kneaded by a melt-kneader. Usable melt-kneaders include single-axis or double-axis continuous kneaders and roll mill batch kneaders. Specific examples of commercially-available melt-kneaders include, but are not limited to, TWIN SCREW EXTRUDER KTK (from Kobe Steel, Ltd.), TWIN SCREW COMPOUNDER TEM (from Toshiba Machine Co., Ltd.), MIRACLE K.C.K (from Asada Iron Works Co., Ltd.), TWIN SCREW EXTRUDER PCM (from Ikegai Co., Ltd.), and KOKNEADER (from Buss Corporation). The melt-kneading conditions are adjusted so as not to cut molecular chains of the binder resin. For example, when the melt-kneading temperature is too much higher than the softening point of the binder resin, molecular chains may be significantly cut. When the melt-kneading temperature is too much lower than the softening point of the binder resin, the raw materials may not be sufficiently kneaded.

Next, the resulting kneaded product is pulverized. The kneaded product may be first pulverized into coarse particles and subsequently pulverized into fine particles. Specific pulverization methods include, for example, a method in which the kneaded product is brought into collision with a collision plate in a jet stream, a method in which particles are brought into collision with each other in a jet stream, and a method in which the kneaded product is pulverized within a narrow gap between mechanically rotating rotor and stator.

The resulting particles are classified by size, and particles within a predetermined size range are collected. Undesired fine particles are removed by cyclone separation, decantation, or centrifugal separation, for example. Undesired coarse or aggregated particles are removed by a sieve having a mesh size of 250 or more. Thus, mother particles are obtained.

According to an embodiment, the mother particle is prepared by the processes of preparing a toner constituents liquid (“oily phase”) by dissolving or dispersing toner constituents including at least a binder resin and/or a precursor thereof in an organic solvent, emulsifying the toner constituents liquid (“oily phase”) in an aqueous medium (“aqueous phase”), and removing the organic solvent from the emulsion. The toner constituents may further include a release agent.

The binder resin may include a combination of a modified polyester having both ester bond and another bond with a crystalline polyester. The precursor may be a resin precursor capable of forming the modified polyester. The resin precursor capable of forming the modified polyester may include a combination of a compound having an active hydrogen group with a polyester having a functional group reactive with the active hydrogen group.

Here, the modified polyester is defined as a polyester having both ester bond and another bond. The modified polyester can be obtained by reacting a compound having an active hydrogen group with a polyester having a functional group reactive with the active hydrogen group. According to an embodiment, the modified polyester has ester bond and urea bond.

The polyester having a functional group reactive with the active hydrogen group may be, for example, a polyester prepolymer having an isocyanate or epoxy group. The polyester having a functional group reactive with the active hydrogen group can be easily obtained by, for example, reacting a compound having an isocyanate or epoxy group with a base polyester. For example, a modified polyester can be obtained by reacting (or elongating) a polyester having an isocyanate group (e.g., a polyester prepolymer) with a compound having an active hydrogen group (e.g., an amine). Such a modified polyester as the binder resin gives a wide fixable temperature range to the toner.

Specific examples of the compound having an isocyanate group include, but are not limited to, aliphatic polyisocyanates (e.g., tetramethylene diisocyanate, hexamethylene diisocyanate, 2,6-diisocyanatomethyl caproate), alicyclic polyisocyanates (e.g., isophorone diisocyanate, cyclohexylmethane diisocyanate), aromatic diisocyanates (e.g., tolylene diisocyanate, diphenylmethane diisocyanate), aromatic aliphatic diisocyanates (e.g., α,α,α′,α′-tetramethylxylylene diisocyanate), isocyanurates, and the above polyisocyanates in which the isocyanate group is blocked with a phenol derivative, an oxime, or a caprolactam.

Specific examples of the compound having an epoxy group include, but are not limited to, epichlorohydrin.

As described above, the binder resin may include a crystalline polyester.

A crystalline polyester can be obtained by reacting alcohol components with acid components. Here, the crystalline polyester is defined as a polyester having a melting point.

Specific examples of usable alcohol components include, but are not limited to, 1,4-butanediol, 1,6-hexanediol, 1,8-octanediol, 1,10-decanediol, and 1,12-dodecanediol. Two or more of these alcohols can be used in combination. Specific examples of usable acid components include, but are not limited to, maleic acid, fumaric acid, succinic acid, 1,4-butanedioic acid, 1,6-hexanedioic acid, 1,8-octanedioic acid, 1,10-decanedioic acid, and 1,12-dodecanedioic acid. Two or more of these acids can be used in combination. More specifically, a crystalline polyester having the following unit (1) may be used.

O—CO—CR₁═CR₂—CO—O—(CH₂)ₙ (1)

wherein each of R₁ and R₂ independently represents a hydrogen atom or a hydrocarbon group having a carbon number of 1 to 20; and n represents a natural number.

Crystallinity and softening point of the crystalline polyester can be controlled by properly introducing a non-linear polyester structure thereto. A non-linear polyester structure can be formed by reacting alcohol components including a polyol having 3 or more valences (e.g., glycerin) with acid components including a polycarboxylic acid having 3 or more valences (e.g., trimellitic anhydride).

Molecular structures of crystalline polyesters can be determined by solid NMR.

Generally, the narrower the molecular weight distribution and the lower the molecular weight of a polymer, the better the low-temperature fixability of the polymer. In view of this, in some embodiments, a molecular weight distribution chart (horizontal axis: log(M), vertical axis: % by weight) measured by GPC of o-dichlorobenzene-soluble components of the crystalline polyester has a peak having a half bandwidth of 1.5 or less within a horizontal range of 3.5 to 4.0. The weight average molecular weight (Mw) is within a range of 1,000 to 6,500, the number average molecular weight (Mn) is within a range of 500 to 2,000, and the ratio Mw/Mn is within a range of 2 to 5.

In some embodiments, when the crystalline polyester is subjected to differential scanning calorimetry (DSC), an endothermic peak is observed at a temperature within a range of 50 to 150° C.

When the endothermic peak is observed at a temperature less than 50° C., heat-resistant storage stability of the toner may be poor. The toner may cause blocking even at the inner temperature of the developing device. When the endothermic peak is observed at a temperature greater than 150° C., the toner may not be reliably fixed on recording media at lower temperatures.

In some embodiments, the crystalline polyester is dispersed within the mother particle forming particles having a long-axis diameter within a range of 0.2 to 3.0

When the long-axis diameter of each dispersed particle is within a range of 0.2 to 3.0 μm, a specific microcrystalline wax can be finely dispersed within the mother particle without being exposed at the surface of the mother particle.

In some embodiments, the crystalline polyester has an acid value within a range of 8 to 45 mgKOH/g. When the acid value is 8 mgKOH/g or more, preferably 20 mgKOH/g or more, such a crystalline polyester has good affinity for paper, which results in improvement of low-temperature fixability of the toner. When the acid value is 45 mgKOH/g or less, hot offset resistance of the toner is improved.

In some embodiments, the crystalline polyester has a hydroxyl value within a range of 0 to 50 mgKOH/g, or 5 to 50 mgKOH/g, in view of low-temperature fixability and chargeability of the toner.

According to an embodiment, the mother particle is prepared by dissolving or dispersing toner constituents including a polyester resin reactive with an active hydrogen group (hereinafter “prepolymer (A)”) in an organic solvent to prepare a toner constituents liquid, dispersing the toner constituents liquid in an aqueous medium containing an inorganic dispersant or a resin particle, and reacting the prepolymer (A) with a compound having an active hydrogen group in the aqueous medium. Here, the toner constituents include raw materials of the mother particle.

The prepolymer (A) is obtained by reacting a polyester resin having an active hydrogen group with a compound having a functional group reactive with the active hydrogen group. The polyester resin having an active hydrogen group is a polycondensation product of a polyol (1) with a polycarboxylic acid (2). The compound having a functional group reactive with the active hydrogen group may be, for example, a polyisocyanate (3). The active hydrogen group may be, for example, a hydroxyl group (e.g., an alcoholic hydroxyl group, a phenolic hydroxyl group), an amino group, a carboxyl group, or a mercapto group.

Specific examples of the polyol (1) include, but are not limited to, alkylene glycols (e.g., ethylene glycol, 1,2-propylene glycol, 1,3-propylene glycol, 1,4-butanediol, 1,6-hexanediol); alkylene ether glycols (e.g., diethylene glycol, triethylene glycol, dipropylene glycol, polyethylene glycol, polypropylene glycol, polytetramethylene ether glycol); alicyclic diols (e.g., 1,4-cyclohexanedimethanol, hydrogenated bisphenol A); bisphenols (e.g., bisphenol A, bisphenol F, bisphenol S); 4,4′-dihydroxy biphenyls (e.g., 3,3′-difluoro-4,4′-dihydroxy biphenyl); bis(hydroxyphenyl)alkanes (e.g., bis(3-fluoro-4-hydroxyphenyl)methane, 1-phenyl-1,1-bis(3-fluoro-4-hydroxyphenyl)ethane, 2,2-bis(3-fluoro-4-hydroxyphenyl)propane, 2,2-bis(3,5-difluoro-4-hydroxyphenyl)propane (also known as tetrafluorobisphenol A), 2,2-bis(3-hydroxyphenyl)-1,1,1,3,3,3-hexafluoropropane); bis(4-hydroxyphenyl) ethers (e.g., bis(3-fluoro-4-hydroxyphenyl)ether); alkylene oxide (e.g., ethylene oxide, propylene oxide, butylene oxide) adducts of the alicyclic diols; and alkylene oxide (e.g., ethylene oxide, propylene oxide, butylene oxide) adducts of the bisphenols. In some embodiments, an alkylene glycol having 2 to 12 carbon atoms or an alkylene oxide adduct of a bisphenol is used. In some embodiments, a mixture of an alkylene oxide adduct of a bisphenol and an alkylene glycol having 2 to 12 carbon atoms is used.

Specific examples of the polyol (1) further include, but are not limited to, polyols having 3 or more valences, such as polyvalent aliphatic alcohols having 3 or more valences (e.g., glycerin, trimethylolethane, trimethylolpropane, pentaerythritol, sorbitol), polyphenols having 3 or more valences (e.g., trisphenol PA, phenol novolac, cresol novolac), and alkylene oxide adducts of the polyphenols having 3 or more valences.

Two or more of these polyols can be used in combination.

Specific examples of the polycarboxylic acid (2) include, but are not limited to, alkylene dicarboxylic acids (e.g., succinic acid, adipic acid, sebacic acid); alkenylene dicarboxylic acids (e.g., maleic acid, fumaric acid); and aromatic dicarboxylic acids (e.g., phthalic acid, isophthalic acid, terephthalic acid, naphthalenedicarboxylic acid, 3-fluoroisophthalic acid, 2-fluoroisophthalic acid, 2-fluoroterephthalic acid, 2,4,5,6-tetrafluoroisophthalic acid, 2,3,5,6-tetrafluoroterephthalic acid, 5-trifluoromethyl isophthalic acid, 2,2-bis(4-carboxyphenyl)hexafluoropropane, 2,2-bis(3-carboxyphenyl)hexafluoropropane, 2,2′-bis(trifluoromethyl)-4,4′-biphenyl dicarboxylic acid, 3,3′-bis(trifluoromethyl)-4,4′-biphenyl dicarboxylic acid, 2,2′-bis(trifluoromethyl)-3,3′-biphenyl dicarboxylic acid, hexafluoroisopropylidene diphthalic anhydride). In some embodiments, an alkenylene dicarboxylic acid having 4 to 20 carbon atoms or an aromatic dicarboxylic acid having 8 to 20 carbon atoms is used.

Specific examples of the polycarboxylic acid (2) further include, but are not limited to, polycarboxylic acids having 3 or more valences, such as aromatic polycarboxylic acids having 9 to 20 carbon atoms (e.g., trimellitic acid, pyromellitic acid); and anhydrides, lower alkyl esters (e.g., methyl ester, ethyl ester, isopropyl ester) of the above aromatic polycarboxylic acids.

Two or more of these polycarboxylic acids can be used in combination.

In some embodiments, the equivalent ratio [OH]/[COOH] of hydroxyl groups [OH] in the polyol (1) to carboxyl groups [COOH] in the polycarboxylic acid (2) is 2/1 to 1/1, 1.5/1 to 1/1, or 1.3/1 to 1.02/1.

In some embodiments, the polyester resin obtained from the polyol (1) and the polycarboxylic acid (2) has a peak molecular weight of 1,000 to 30,000, 1,500 to 10,000, or 2,000 to 8,000. When the peak molecular weight is less than 1,000, heat-resistant storage stability of the toner may be poor. When the peak molecular weight is greater than 10,000, low-temperature fixability of the toner may be poor.

Specific examples of the polyisocyanate (3) include, but are not limited to, aliphatic polyisocyanates (e.g., tetramethylene diisocyanate, hexamethylene diisocyanate, 2,6-diisocyanatomethyl caproate), alicyclic polyisocyanates (e.g., isophorone diisocyanate, cyclohexylmethane diisocyanate), aromatic diisocyanates (e.g., tolylene diisocyanate, diphenylmethane diisocyanate), aromatic aliphatic diisocyanates (e.g., α,α,α′,α′-tetramethylxylylene diisocyanate), isocyanurates, and the above polyisocyanates in which the isocyanate group is blocked with a phenol derivative, an oxime, or a caprolactam. Two or more of these materials can be used in combination.

In some embodiments, the equivalent ratio [NCO]/[OH] of isocyanate groups [NCO] in the polyisocyanate (3) to hydroxyl groups [OH] in the polyester resin having an active hydrogen group is 5/1 to 1/1, 4/1 to 1.2/1, or 2.5/1 to 1.5/1. When the equivalent ratio [NCO]/[OH] is greater than 5, low-temperature fixability of the toner may be poor. When the equivalent ratio [NCO]/[OH] is less than 1, hot offset resistance of the toner may be poor because the content of urethane and urea groups in the resulting modified polyester is too small.

In some embodiments, the prepolymer (A) includes units from the polyisocyanate (3) in an amount of 0.5 to 40% by weight, 1 to 30% by weight, or 2 to 20% by weight. When the content of the units is less than 0.5% by weight, offset resistance of the toner may be poor. When the content of the units is greater than 40% by weight, low-temperature fixability of the toner may be poor.

In some embodiments, the number of isocyanate groups included in one molecule of the prepolymer (A) is 1 or more, 1.5 to 3, or 1.8 to 2.5. When the number of isocyanate groups is less than 1, offset resistance of the toner may be poor because the molecular weight of the resulting modified polyester is too small.

The compound having an active hydrogen group (as an elongating and/or cross-linking agent) may be, for example, an amine (B). The amine (B) may be, for example, a diamine (B1), a polyamine (B2) having 3 or more valences, an amino alcohol (B3), an amino mercaptan (B4), an amino acid (B5), or a blocked amine (B6) in which the amino group in any of the amines (B1) to (B5) is blocked.

Specific examples of the diamine (B1) include, but are not limited to, aromatic diamines (e.g., phenylenediamine, diethyltoluenediamine, 4,4′-diaminodiphenylmethane, tetrafluoro-p-xylylenediamine, tetrafluoro-p-phenylenediamine); alicyclic diamines (e.g., 4,4′-diamino-3,3′-dimethyldicyclohexylmethane, diaminocyclohexane, isophoronediamine); and aliphatic diamines (e.g., ethylenediamine, tetramethylenediamine, hexamethylenediamine, dodecafluorohexylenediamine, tetracosafluorododecylenediamine).

Specific examples of the polyamine (B2) having 3 or more valences include, but are not limited to, diethylenetriamine and triethylenetetramine.

Specific examples of the amino alcohol (B3) include, but are not limited to, ethanolamine and hydroxyethylaniline.

Specific examples of the amino mercaptan (B4) include, but are not limited to, aminoethyl mercaptan and aminopropyl mercaptan.

Specific examples of the amino acid (B5) include, but are not limited to, aminopropionic acid and aminocaproic acid.

Specific examples of the blocked amine (B6) include, but are not limited to, ketimine compounds obtained from the above-described amines (B1) to (B5) and ketones (e.g., acetone, methyl ethyl ketone, methyl isobutyl ketone), and oxazoline compounds.

To control the molecular weight of the resulting modified polyester, a reaction terminator that terminates elongation and/or cross-linking reactions between the prepolymer (A) and the amine (B) can be used. Specific examples of usable reaction terminators include, but are not limited to, monoamines (e.g., diethylamine, dibutylamine, butylamine, laurylamine) and blocked monoamines (e.g., ketimine compounds).

In some embodiments, the equivalent ratio [NCO]/[NHx] of isocyanate groups [NCO] in the prepolymer (A) to amino groups [NHx] in the amine (B) is 1/2 to 2/1, 1.5/1 to 1/1.5, or 1.2/1 to 1/1.2. When the equivalent ratio [NCO]/[NHx] is greater than 2 or less than ½, hot offset resistance of the toner may be poor because the molecular weight of the resulting modified polyester is too small.

The organic solvent in which the toner constituents are dissolved or dispersed may be a volatile solvent having a boiling point less than 100° C. Such a solvent is easily removable in succeeding processes. Specific examples of such organic solvents include, but are not limited to, toluene, xylene, benzene, carbon tetrachloride, methylene chloride, 1,2-dichloroethane, 1,1,2-trichloroethane, trichloroethylene, chloroform, monochlorobenzene, dichloroethylidene, methyl acetate, ethyl acetate, methyl ethyl ketone, and methyl isobutyl ketone. Two or more of these solvents can be used in combination. In some embodiments, an ester solvent (e.g., methyl acetate, ethyl acetate), an aromatic solvent (e.g., toluene, xylene), or a halogenated hydrocarbon (e.g., methylene chloride, 1,2-dichloroethane, chloroform, carbon tetrachloride) is used. Each of the toner constituents may be dissolved or dispersed in the organic solvent either simultaneously or independently. In the latter case, each of the toner constituents may be dissolved or dispersed in an independent organic solvent. In some embodiments, in view of ease of solvent removal treatment, all of the toner constituents are dissolved or dispersed in a single organic solvent.

In some embodiments, the resin content in the toner constituents liquid is 40 to 80% by weight. When the resin content is greater than 80% by weight, it may be difficult to dissolve or disperse the toner constituents and the viscosity of the toner constituents liquid is too high to handle. When the resin content is less than 40% by weight, the toner production may be too small. When a polyester resin and a prepolymer are used in combination, each of them may be dissolved or dispersed in either a single organic solvent or an independent organic solvent. Because of having different solubility and viscosity, each of the polyester resin and the prepolymer may be dissolved or dispersed in an independent organic solvent.

The colorant may be dissolved or dispersed in an organic solvent independently. Alternatively, the colorant may be dissolved or dispersed in the solution or dispersion of the polyester resin prepared above. An auxiliary dispersant or a polyester resin may be further added to the colorant solution or dispersion. The colorant may be also used in the form of master batch.

The aqueous medium may be, for example, water alone or a mixture of water with a water-miscible solvent. Specific examples of usable water miscible solvents include, but are not limited to, alcohols (e.g., methanol, isopropanol, ethylene glycol), dimethylformamide, tetrahydrofuran, cellosolves (e.g., methyl cellosolve), and lower ketones (e.g., acetone, methyl ethyl ketone). In some embodiments, the amount of the aqueous medium is 50 to 2,000 parts by weight or 100 to 1,000 parts by weight, based on 100 parts by weight of the toner constituents. When the amount of the aqueous medium is less than 50 parts by weight, the toner constituents may not be finely dispersed. When the amount of the aqueous medium is greater than 2,000 parts by weight, manufacturing cost may increase.

The aqueous medium, in which the toner constituents liquid is to be dispersed, may contain an inorganic dispersant or a resin particle so that the resulting particles are reliably dispersed in the aqueous medium while having a narrow size distribution.

Specific examples of usable inorganic dispersants include, but are not limited to, tricalcium phosphate, calcium carbonate, titanium oxide, colloidal silica, and hydroxyapatite.

The resin particle may be comprised of a resin capable of forming an aqueous dispersion thereof. Specific examples of such resins include, but are not limited to, thermoplastic and thermosetting resins such as vinyl resin, polyurethane resin, epoxy resin, polyester resin, polyamide resin, polyimide resin, silicone resin, phenol resin, melamine resin, urea resin, aniline resin, ionomer resin, and polycarbonate resin. Two or more of these resins can be used in combination. In some embodiments, a vinyl resin, a polyurethane resin, an epoxy resin, a polyester resin, or a combination thereof is used because they are easy to form an aqueous dispersion of fine spherical particles thereof.

An aqueous dispersion of the resin particle may be produced by the following procedures (a) to (h), for example.

(a) An aqueous dispersion of a vinyl resin is obtainable by directly subjecting raw materials of the resin including a monomer to a suspension polymerization, a seed polymerization, or a dispersion polymerization.
(b) An aqueous dispersion of a polyaddition or polycondensation resin (e.g., polyester resin, polyurethane resin, epoxy resin) is obtainable by dispersing a precursor (e.g., monomer, oligomer) of the resin or a solution thereof in an aqueous medium in the presence of a dispersant, and curing the precursor by application of heat or addition of a curing agent.
(c) An aqueous dispersion of a polyaddition or polycondensation resin (e.g., polyester resin, polyurethane resin, epoxy resin) is obtainable by dissolving an emulsifier in a precursor (e.g., monomer, oligomer) of the resin or a solution (preferably in a liquid state, or which may be liquefied by application of heat) thereof, and further adding water thereto to cause phase-transfer emulsification.
(d) An aqueous dispersion of a resin produced by a polymerization reaction (e.g., addition polymerization, ring-opening polymerization, polyaddition, addition condensation, polycondensation) is obtainable by pulverizing the resin into particles by a mechanical rotary pulverizer or a jet pulverizer, classifying the particles by size to collect desired-size particles, and dispersing the collected particles in an aqueous medium in the presence of a dispersant.
(e) An aqueous dispersion of a resin produced by a polymerization reaction (e.g., addition polymerization, ring-opening polymerization, polyaddition, addition condensation, polycondensation) is obtainable by dissolving the resin in a solvent, spraying the resulting resin solution to form resin particles, and dispersing the resin particles in an aqueous medium in the presence of a dispersant.
(f) An aqueous dispersion of a resin produced by a polymerization reaction (e.g., addition polymerization, ring-opening polymerization, polyaddition, addition condensation, polycondensation) is obtainable by dissolving the resin in a solvent and further adding a solvent to the resulting resin solution, or dissolving the resin in a solvent by application of heat and cooling the resulting resin solution, to precipitate resin particles, removing the solvent to isolate the resin particles, and dispersing the resin particles in an aqueous medium in the presence of a dispersant.
(g) An aqueous dispersion of a resin produced by a polymerization reaction (e.g., addition polymerization, ring-opening polymerization, polyaddition, addition condensation, polycondensation) is obtainable by dissolving the resin in a solvent, dispersing the resulting resin solution in an aqueous medium in the presence of a dispersant, and removing the solvent by application of heat and/or reduction of pressure.
(h) An aqueous dispersion of a resin produced by a polymerization reaction (e.g., addition polymerization, ring-opening polymerization, polyaddition, addition condensation, polycondensation) is obtainable by dissolving the resin in a solvent, dissolving an emulsifier in the resulting resin solution, and adding water thereto to cause phase-transfer emulsification.

The aqueous medium may further contain a surfactant to reliably disperse the toner constituents liquid. Specific examples of usable surfactants include, but are not limited to, anionic surfactants such as alkylbenzene sulfonates, α-olefin sulfonates and phosphates; cationic surfactants such as amine salt type surfactants (e.g., alkylamine salts, amino alcohol fatty acid derivatives, polyamine fatty acid derivatives, imidazoline) and quaternary ammonium salt type surfactants (e.g., alkyl trimethyl ammonium salts, dialkyl dimethyl ammonium salts, alkyl dimethyl benzyl ammonium salts, pyridinium salts, alkyl isoquinolinium salts, and benzethonium chloride); nonionic surfactants such as fatty acid amide derivatives and polyvalent alcohol derivatives; and ampholytic surfactants such as alanine, dodecylbis(aminoethyl)glycine, bis(octylaminoethyl)glycine, and N-alkyl-N,N-dimethyl ammonium betaine.

Surfactants having a fluoroalkyl group can achieve an effect in a small amount. Specific examples of usable anionic surfactants having a fluoroalkyl group include, but are not limited to, fluoroalkyl carboxylic acids having 2 to 10 carbon atoms and metal salts thereof, perfluorooctane sulfonyl glutamic acid disodium, 3-[ω-fluoroalkyl(C6-C11)oxy]-1-alkyl(C3-C4) sulfonic acid sodium, 3-[w-fluoroalkanoyl(C6-C8)-N-ethylamino]-1-propane sulfonic acid sodium, fluoroalkyl(C11-C20) carboxylic acids and metal salts thereof, perfluoroalkyl(C7-C13) carboxylic acids and metal salts thereof, perfluoroalkyl(C4-C12) sulfonic acids and metal salts thereof, perfluorooctane sulfonic acid diethanol amide, N-propyl-N-(2-hydroxyethyl)perfluorooctane sulfonamide, perfluoroalkyl(C6-C10) sulfonamide propyl trimethyl ammonium salts, perfluoroalkyl(C6-C10)-N-ethyl sulfonyl glycine salts, and monoperfluoroalkyl(C6-C16) ethyl phosphates. Specific examples of usable cationic surfactants having a fluoroalkyl group include, but are not limited to, aliphatic primary, secondary, and tertiary amine acids having a fluoroalkyl group, aliphatic quaternary ammonium salts such as perfluoroalkyl(C6-C10) sulfonamide propyl trimethyl ammonium salts, benzalkonium salts, benzethonium chlorides, pyridinium salts, and imidazolinium salts.

The aqueous medium may further contain a polymeric protection colloid to stabilize dispersing liquid droplets. Specific examples of usable polymeric protection colloids include, but are not limited to, homopolymers and copolymers obtained from monomers, such as acids (e.g., acrylic acid, methacrylic acid, α-cyanoacrylic acid, α-cyanomethacrylic acid, itaconic acid, crotonic acid, fumaric acid, maleic acid, maleic anhydride), hydroxyl-group-containing acrylates and methacrylates (e.g., β-hydroxyethyl acrylate, β-hydroxyethyl methacrylate, β-hydroxypropyl acrylate, β-hydroxypropyl methacrylate, γ-hydroxypropyl acrylate, γ-hydroxypropyl methacrylate, 3-chloro-2-hydroxypropyl acrylate, 3-chloro-2-hydroxypropyl methacrylate, diethylene glycol monoacrylate, diethylene glycol monomethacrylate, glycerin monoacrylate, glycerin monomethacrylate), vinyl alcohols and vinyl alcohol ethers (e.g., vinyl methyl ether, vinyl ethyl ether, vinyl propyl ether), esters of vinyl alcohols with carboxyl-group-containing compounds (e.g., vinyl acetate, vinyl propionate, vinyl butyrate), amides (e.g., acrylamide, methacrylamide, diacetone acrylamide) and methylol compounds thereof (e.g., N-methylol acrylamide, N-methylol methacrylamide), acid chlorides (e.g., acrylic acid chloride, methacrylic acid chloride), and monomers containing nitrogen or a nitrogen-containing heterocyclic ring (e.g., vinyl pyridine, vinyl pyrrolidone, vinyl imidazole, ethylene imine); polyoxyethylenes (e.g., polyoxyethylene, polyoxypropylene, polyoxyethylene alkylamine, polyoxypropylene alkylamine, polyoxyethylene alkylamide, polyoxypropylene alkylamide, polyoxyethylene nonyl phenyl ether, polyoxyethylene lauryl phenyl ether, polyoxyethylene stearyl phenyl ester, polyoxyethylene nonyl phenyl ester); and celluloses (e.g., methyl cellulose, hydroxyethyl cellulose, hydroxypropyl cellulose).

In a case in which a dispersant soluble in acids and bases (e.g., calcium phosphate) is used, the resulting mother particles may be first washed with an acid (e.g., hydrochloric acid) and then washed with water to remove the dispersant. Alternatively, such a dispersant can be removed with an enzyme. Dispersants may either keep remaining on the surface of the mother particle or be removed from the surface of the mother particle in terms of chargeability.

The toner constituents liquid is dispersed in the aqueous medium using a low-speed shearing disperser, a high-speed shearing disperser, a frictional disperser, a high-pressure jet disperser, or an ultrasonic disperser, for example. In some embodiments, a high-speed shearing disperser is used to make the dispersing liquid droplets have an average particle diameter of 2 to 20 μm. In such embodiments, the high-speed shearing disperser operates at a revolution of 1,000 to 30,000 rpm or 5,000 to 20,000 rpm. The dispersing time may be 0.1 to 5 minutes for a batch type. The dispersing temperature may be 0 to 150° C. (under pressure) or 20 to 80° C.

The solvent can be removed from the resulting emulsion by gradually heating the emulsion under normal or reduced pressures to completely evaporate the solvent from liquid droplets. Alternatively, the solvent can be removed from the emulsion by spraying the emulsion into dry atmosphere to completely evaporate the solvent from liquid droplets. In this case, the surfactant can also be evaporated. The dry atmosphere into which the emulsion is sprayed may be, for example, air, nitrogen gas, carbon dioxide gas, or combustion gas, which is heated to above the boiling point of the solvent. Such a treatment can be reliably performed by a spray drier, a belt drier, or a rotary kiln, within a short period of time.

The amine (B) may be previously mixed with the toner constituents liquid before the toner constituents liquid is added to the aqueous medium. Alternatively, the amine (B) may be added to the aqueous medium after the toner constituents liquid is dispersed therein. The reaction time between the prepolymer (A) and the amine (B) may be 1 minute to 40 hours or 1 to 24 hours. The reaction temperature may be 0 to 150° C. or 20 to 98° C. A catalyst can be used, if needed.

The mother particle dispersed in the aqueous medium may be washed and dried out by any known procedure. For example, one procedure includes subjecting the emulsion to solid-liquid separation by centrifugal separation or filter press to obtain a toner cake, redispersing the toner cake in ion-exchange water having a normal temperature to a temperature around 40° C., optionally controlling the pH by addition of an acid or an alkaline, and subjecting the dispersion to solid-liquid separation again. This procedure is repeated for several times. Thus, impurities and surfactants are removed in the above procedure. The mother particle is then dried out by a flash drier, a circulating drier, a reduced-pressure drier, or a vibrating fluidizing drier. Undesired fine particles may be removed in the process of centrifugal separation. The dried mother particle may be subjected to classification by a classifier to collect particles having a desired particle diameter distribution.

The outer shell layer is formed by reacting a specific silicon compound with a surface of the mother particle. Specific examples of usable silicon compounds include, but are not limited to, tetraalkoxysilane compounds (e.g., tetramethoxysilane, tetraethoxysilane, tetrapropoxysilane, tetrabutoxysilane), alkyl alkoxysilane compounds (e.g., monomethyl trimethoxysilane, dimethyl dimethoxysilane, trimethyl monomethoxysilane, monoethyl trimethoxysilane, diethyl dimethoxysilane, triethyl monomethoxysilane), phenyl alkoxysilane compounds (e.g., phenyl trimethoxysilane, diphenyl dimethoxysilane, triphenyl monomethoxysilane), amino-group-containing silane compounds (e.g., aminopropyl trimethoxysilane, (aminoethyl)aminopropyl dimethoxysilane, aminopropyl triethoxysilane, aminopropyl dimethyl ethoxysilane, aminopropyl methyl diethoxysilane, aminobutyl triethoxysilane), vinyl-group-containing silane compounds (e.g., vinyl trimethoxysilane, vinyl triethoxysilane), glycidyl-group-containing silane compounds (e.g., 3-glycidoxypropyl methyl ethoxysilane, 3-glycidoxypropyl triethoxysilane), acrylic-group-containing or methacrylic-group-containing silane compounds (e.g., 3-methacryloxypropyl methyl dimethoxysilane, 3-methacryloxypropyl trimethoxysilane, 3-methacryloxypropyl methyl diethoxysilane, 3-methacryloxypropyl triethoxysilane, 3-acryloxypropyl trimethoxysilane), chlorosilane compounds (e.g., monochlorosilane, dichlorosilane, trichlorosilane), and silicates (e.g., sodium silicate, potassium silicate).

To react the silicon compound with the surfaces of the mother particles, the mother particles in an amount of 0.1 to 30% by weight are dispersed in water or a mixed liquid of water and an organic solvent, the silicon compound is then added thereto at a temperature of 0 to 50° C., and the mixture is agitated for 1 to 48 hours at that temperature. The reaction system is then aged for 1 to 20 hours at a temperature of 60 to 80° C., in the presence of a catalyst, if needed. Specific examples of usable catalysts include, but are not limited to, strong acids (e.g., sulfuric acid, toluenesulfonic acid), metal halides (e.g., titanium tetrachloride, hafnium chloride, zirconium chloride, aluminum chloride, gallium chloride, indium chloride, iron chloride, tin chloride, boron fluoride), hydroxides, alcoholates, or carbonates of alkaline or alkaline-earth metals (e.g., sodium hydroxide, potassium hydroxide, sodium methylate, sodium carbonate), metal oxides (e.g., aluminum oxide, calcium oxide, barium oxide, sodium oxide), and organic metal compounds (e.g., tetraisopropyl titanate, dibutyltin dichloride, dibutyltin oxide).

When a tetraalkoxysilane compound, chlorosilane compound, or silicate is reacted with the surface of the mother particle, the resulting outer shell layer becomes a silica layer. When an alkyl-modified or amino-modified silicon compound is reacted with the surface of the mother particle, the resulting outer shell layer becomes an alkyl-modified or amino-modified silica layer, respectively.

In some embodiments, the amount of the silicon compound to be reacted with the surface of the mother particle is determined such that 100 parts of the mother particles include silicon atoms in an amount of 0.5 to 30 parts by weight, 0.8 to 20 parts by weight, or 1 to 10 parts by weight. When the amount of the silicon compound is too small, the outer shell layer may not be reliably formed. When the amount of the silicon compound is too large, the mother particles may coalesce or aggregate with each other.

As described above, when a tetraalkoxysilane compound is reacted with the surface of the mother particle, the resulting outer shell layer becomes a silica layer. In this case, a modified silicon compound may be further reacted with the surface of the silica layer to further form a modified silica layer thereon, for adjusting chargeability.

Specific examples of usable modified silicon compounds include, but are not limited to, alkyl alkoxysilane compounds (e.g., monomethyl trimethoxysilane, dimethyl dimethoxysilane, trimethyl monomethoxysilane, monoethyl trimethoxysilane, diethyl dimethoxysilane, triethyl monomethoxysilane), phenyl alkoxysilane compounds (e.g., phenyl trimethoxysilane, diphenyl dimethoxysilane, triphenyl monomethoxysilane), amino-group-containing silane compounds (e.g., aminopropyl trimethoxysilane, (aminoethyl)aminopropyl dimethoxysilane, aminopropyl triethoxysilane, aminopropyl dimethyl ethoxysilane, aminopropyl methyl diethoxysilane, aminobutyl triethoxysilane), vinyl-group-containing silane compounds (e.g., vinyl trimethoxysilane, vinyl triethoxysilane), glycidyl-group-containing silane compounds (e.g., 3-glycidoxypropyl methyl ethoxysilane, 3-glycidoxypropyl triethoxysilane), acrylic-group-containing or methacrylic-group-containing silane compounds (e.g., 3-methacryloxypropyl methyl dimethoxysilane, 3-methacryloxypropyl trimethoxysilane, 3-methacryloxypropyl methyl diethoxysilane, 3-methacryloxypropyl triethoxysilane, 3-acryloxypropyl trimethoxysilane), and fluorine-containing silane compounds (e.g., nonafluorohexyl trimethoxysilane, nonafluorohexyl triethoxysilane, tridecafluorohexyl trimethoxysilane, tridecafluorohexyl triethoxysilane). Two or more of these compounds can be used in combination.

The modified silicon compound is directly reacted with the surface of the mother particle on which the silica layer has been formed.

In some embodiments, the amount of the modified silicon compound to be reacted with the surface of the mother particle is determined such that the amount of silicon atoms from the modified silicon compound becomes 0.01 to 5 moles, 0.1 to 3 moles, or 0.5 to 2 moles based on 1 mole of silicon atoms from the tetraalkoxysilane compound that is a raw material of the silica layer. When the amount of the modified silicon compound is too small, the modified silicon compound cannot sufficiently exert its effect. When the amount of the modified silicon compound is too large, the mother particles may coalesce or aggregate with each other. To react the modified silicon compound with the mother particles, the mother particles having the silica layer in an amount of 0.1 to 30% by weight are dispersed in water or a mixed liquid of water and an organic solvent, the modified silicon compound is then added thereto at a temperature of 0 to 50° C., and the mixture is agitated for 1 to 48 hours at that temperature. The reaction system is then aged for 1 to 20 hours at a temperature of 60 to 80° C.

The toner particle may further include an external additive to more improve fluidity, storage stability, developability, and transferability. The mother particle and the external additive may be mixed by a typical powder mixer which may be equipped with a jacket that controls the inner temperature. To vary load history given to the external additive, the external additive may be gradually added or added from the middle of the mixing, while optionally varying the revolution, rotating speed, time, and temperature in the mixing. The load may be initially strong and gradually weaken, or vice versa. Specific usable mixers include, but are not limited to, a V-type mixer, a Rocking mixer, a Loedige mixer, a Nauta mixer, and a Henschel mixer.

According to some embodiments, the volume average particle diameter (Dv) of the toner particle is not less than 3.0 μm and less than 6.0 μm and the ratio (Dv/Dn) of the volume average particle diameter (Dv) to the number average particle diameter (Dn) is within a range of 1.05 to 1.25, or 1.05 to 1.20.

The toner particle according to an embodiment provides a good combination of heat-resistant storage stability, low-temperature fixability, hot offset resistance, and proper image gloss, without contaminating charging members (e.g., carrier particles, a charging blade), degrading chargeability, or scattering. When the toner particle is used for a two-component developer, the average toner particle size may not vary very much although consumption and supply of the toner particles are repeated. Thus, the two-component developer reliably provides stable developability for an extended period of time.

When the toner particle is used for a one-component developer, the average toner particle size may not vary very much although consumption and supply of the toner particles are repeated. Additionally, the toner particles may not adhere or fix to a developing roller or a toner layer regulating blade. Thus, the one-component developer reliably provides stable developability and image quality for an extended period of time.

Generally, the smaller the particle diameter of toner particle, the better the resolution and quality of the resulting toner image but the worse the transferability and cleanability of the toner particle. When toner particles having a volume average particle diameter beyond the above-described range are used for a two-component developer and agitated in a developing device for a long term, the toner particles may adhere to carrier particles and degrade charging ability thereof. When such toner particles are used for a one-component developer, the toner particles may fixedly adhere to a developing roller or a toner layer regulating blade. When the content of undesired ultrafine particles is too large, the same phenomena may occur.

It may be difficult for toner particles having a particle diameter beyond the above-described range to produce high-resolution and high-quality toner image. The average toner particle size may vary very much as the toner particles are repeatedly consumed and supplied. When the ratio (Dv/Dn) is greater than 1.25, the same phenomena may occur. When the ratio (Dv/Dn) is less than 1.05, behavior of the toner particles is stabilized and changeability thereof is homogenized, however, the toner particles may not be sufficiently charged or cleanability may deteriorate.

A developer according to an embodiment may be either a one-component developer including the toner particle according to an embodiment and no carrier particle, or a two-component developer including the toner particle according to an embodiment and a carrier particle. The two-component developer may be used for high-speed printers in accordance with recent improvement in information processing speed because of having a long lifespan. In some embodiments, the two-component developer includes the toner particle in an amount of 1 to 10 parts by weight based on 100 parts by weight of the carrier particle.

In the one-component developer according to an embodiment, the average toner particle size may not vary very much although consumption and supply of the toner particles are repeated. Additionally, the toner particles may not adhere or fix to a developing roller or a toner layer regulating blade. Thus, the one-component developer reliably provides stable developability and image quality for an extended period of time. In the two-component developer according to an embodiment, the average toner particle size may not vary very much although consumption and supply of the toner particles are repeated. Thus, the two-component developer reliably provides stable developability for an extended period of time.

The carrier particle may comprise a core material and a resin layer that covers the core material.

Specific examples of usable core materials include, but are not limited to, manganese-strontium (Mn—Sr) and manganese-magnesium (Mn—Mg) materials having a magnetization of 50 to 90 emu/g. High magnetization materials such as iron powders having a magnetization of 100 emu/g or more and magnetites having a magnetization of 75 to 120 emu/g are suitable for improving image density. Additionally, low magnetization materials such as copper-zinc (Cu—Zn) materials having a magnetization of 30 to 80 emu/g are suitable for producing a high-quality image, because carrier particles made of such materials can weakly contact a photoreceptor. Two or more of these materials can be used in combination.

In some embodiments, the core material has a weight average particle diameter of 10 to 200 μm or 40 to 100 μm. When the weight average particle diameter is less than 10 μm, it means that the resulting carrier particles include a relatively large amount of fine particles, and therefore the magnetization per carrier particle is too low to prevent carrier particles from scattering. When the weight average particle diameter is greater than 200 μm, it means that the specific surface area of the carrier particle is too small to prevent toner particles from scattering. Therefore, solid portions in full-color images may not be reliably reproduced.

Specific examples of usable resins for the resin layer include, but are not limited to, amino resins, polyvinyl resins, polystyrene resins, halogenated olefin resins, polyester resins, polycarbonate resins, polyethylene resins, polyvinyl fluoride resins, polyvinylidene fluoride resins, poly(trifluoroethylene) resins, poly(hexafluoropropylene) resins, vinylidene fluoride-acrylic monomer copolymer, vinylidene fluoride-vinyl fluoride copolymer, tetrafluoroethylene-vinylidene fluoride-non-fluoride monomer terpolymer, and silicone resins. Two or more of these resins can be used in combination.

Specific examples of the amino resins include, but are not limited to, urea-formaldehyde resin, melamine resin, benzoguanamine resin, urea resin, polyamide resin, and epoxy resin. Specific examples of the polyvinyl resins include, but are not limited to, acrylic resin, polymethyl methacrylate, polyacrylonitrile, polyvinyl chloride, polyvinyl alcohol, and polyvinyl butyral. Specific examples of the polystyrene resins include, but are not limited to, polystyrene and styrene-acrylic copolymer. Specific examples of the halogenated olefin resins include, but are not limited to, polyvinyl chloride. Specific examples of the polyester resins include, but are not limited to, polyethylene terephthalate and polybutylene terephthalate.

The resin layer may contain a conductive powder. Specific examples of usable conductive powders include, but are not limited to, metal, carbon black, titanium oxide, tin oxide, and zinc oxide. In some embodiments, the conductive powder has an average particle diameter of 1 μm or less. When the average particle diameter is greater than 1 μm, it may be difficult to control electric resistivity of the resin layer.

The resin layer can be formed by, for example, dissolving a resin (e.g., a silicone resin) in a solvent to prepare a coating liquid, and uniformly applying the coating liquid on the surface of the core material, followed by drying and baking. The coating method may be, for example, dip coating, spray coating, or brush coating.

Specific examples of usable solvents include, but are not limited to, toluene, xylene, methyl ethyl ketone, methyl isobutyl ketone, methyl cellosolve, and butyl acetate.

The baking method may be either an external heating method or an internal heating method that uses a stationary electric furnace, a fluid electric furnace, a rotary electric furnace, a burner furnace, or microwave.

In some embodiments, the content of the resin layer in the carrier particle is 0.01 to 5.0% by weight. When the content of the resin layer is less than 0.01% by weight, it means that the resin layer cannot be uniformly formed on the core material. When the content of the resin layer is greater than 5.0% by weight, it means that the resin layer is so thick that each carrier particles may be fused with each other.

The developer may be used for any electrophotographic methods, such as magnetic one-component developing methods, non-magnetic one-component developing methods, and two-component developing methods.

The developer according to an embodiment may be contained in a process cartridge that integrally supports at least an image bearing member on which an electrostatic latent image is formed and a developing device that develops the electrostatic latent image into a toner image with the developer. The process cartridge is detachably attachable to image forming apparatuses. The process cartridge may further include other devices.

FIGURE is a schematic view of a process cartridge according to an embodiment. The process cartridge includes a photoreceptor 10 serving as the image bearing member, a charger 20, an irradiator 30, a developing device 40, a cleaning device 60, and a transfer device 80.

An image forming method according to an embodiment includes the processes of forming an electrostatic latent image, developing, transfer, and fixing. The image forming method may further include the process of neutralization, cleaning, recycle, and control, if needed.

The developer according to an embodiment can be used for an image forming apparatus including a photoreceptor (i.e., an image bearing member), a charger, a developing device, a transfer device, and a fixing device. The image forming apparatus may further include a neutralizer, a cleaner, a recycler and a controller, if needed.

In the process of forming an electrostatic latent image, an electrostatic latent image is formed on a photoreceptor. A charger uniformly charges a surface of the photoreceptor by supplying a voltage to the surface and an irradiator irradiates the charged surface with light containing image information.

The photoreceptor is not limited in material, shape, structure, or size. In some embodiments, the photoreceptor has a drum-like shape. The photoreceptor may be comprised of an inorganic photoconductor, such as amorphous silicone and selenium, or an organic photoconductor, such as polysilane and phthalopolymethyne. In some embodiments, amorphous silicone is used because of having a long lifespan.

The charger may be, for example, either a contact charger equipped with a conductive or semiconductive roll, brush, film, or rubber blade, or a non-contact charger such as corotron and scorotron that use corona discharge. The charger is disposed either contacting or non-contacting the photoreceptor. In some embodiments, the charger charges a surface of the photoreceptor by being supplied with a direct current voltage overlapped with an alternating current voltage. In some embodiments, the charger is a non-contact charging roller disposed proximal to the photoreceptor which charges a surface of the photoreceptor by being supplied with a direct current voltage overlapped with an alternating current voltage.

The irradiator may be, for example, a radiation optical type, a rod lens array type, a laser optical type, or a liquid crystal shutter optical type. The photoreceptor may be irradiated with light from the reverse surface (back surface) side thereof.

In the process of developing, the electrostatic latent image is developed into a toner image that is visible with the developer according to an embodiment.

In some embodiments, the developing device includes a container that contains the developer according to an embodiment and a developer bearing member that supplies the developer to the electrostatic latent image with or without contacting the electrostatic latent image. The developing device may employ either a dry developing method or a wet developing method. The developing device may be either a single-color developing device or a multi-color developing device. The developing device may be comprised of an agitator that frictionally agitates and charges the developer, and a rotatable magnet roller. In the developing device, toner particles and carrier particles are mixed and agitated so that the toner particles are frictionally charged. The charged toner particles and carrier particles are borne on the surface of the magnet roller forming chainlike aggregations (hereinafter “magnetic brush”). The magnet roller is disposed adjacent to the photoreceptor. Therefore, a part of the toner particles in the magnetic brush migrates from the surface of the magnet roller to the surface of the photoreceptor due to electrical attractive force. As a result, the electrostatic latent image formed on the photoreceptor is developed into a toner image. During migration of the toner particles to the surface of the photoreceptor, an alternation electric field may be applied.

In the process of transfer, the toner image is transferred from the photoreceptor onto a recording medium. In some embodiments, the toner image is primarily transferred from the photoreceptor onto an intermediate transfer medium, and secondarily transferred from the intermediate transfer medium onto the recording medium. In such embodiments, multiple toner images with different colors are primarily transferred from the respective photoreceptors onto the intermediate transfer medium to form a composite toner image, and the composite toner image is secondarily transferred from the intermediate transfer medium onto the recording medium. The toner image can be transferred from the photoreceptor upon charging the photoreceptor by a transfer charger.

In some embodiments, the transfer device includes a primary transfer device that transfers toner images from the respective photoreceptors onto the intermediate transfer medium to form a composite toner image, and a secondary transfer device that transfers the composite toner image from the intermediate transfer medium onto a recording medium. In such embodiments, the transfer device (including the primary transfer device and the secondary transfer device) contains a transfer unit that separates a toner image from the photoreceptor toward a recording medium side. The number of the transfer device may be one or more. The transfer unit may be, for example, a corona discharger, a transfer belt, a transfer roller, a pressure transfer roller, or an adhesive transfer unit.

The intermediate transfer medium may be, for example, a transfer belt.

The recording medium is not limited to a specific material, and any kind of material can be used as the recording medium.

In the process of fixing, the fixing device fixes the toner image on a recording medium. Each single-color toner image may be independently fixed on a recording medium. Alternatively, a composite toner image including multiple color toner images may be fixed on a recording medium at once.

In some embodiments, the fixing device includes fixing members that fix a toner image by application of heat and pressure. The fixing members may have either a roller-like or belt-like shape. For example, the fixing device may include a combination of a heating roller and a pressing roller, or a combination of a heating roller, a pressing roller, and an endless belt. The heating temperature may be 80 to 200° C.

In some embodiments, the fixing device includes a heater equipped with a heating element, a film in contact with the heater, and a pressing member that presses against the heater with the film therebetween. A recording medium having a toner image thereon is passed through between the film and the pressing member so that the toner image is fixed on the recording medium by application of heat and pressure.

In the fixing process, an optical fixer can be used in place of or in combination with the fixing device.

In the process of neutralization, the neutralizer neutralizes the photoreceptor by applying a neutralization bias thereto. The neutralizer may be, for example, a neutralization lamp.

In the process of cleaning, the cleaner removes residual toner particles remaining on the photoreceptor. The cleaner may be, for example, a magnetic brush cleaner, an electrostatic brush cleaner, a magnetic roller cleaner, a blade cleaner, a brush cleaner, or a web cleaner.

In the process of recycle, the recycler supplies the residual toner particles collected in the cleaning process to the developing device. The recycler may be, for example, a conveyer.

In the process of control, the controller controls the above-described processes. The controller may be, for example, a sequencer or a computer.

### EXAMPLES

Having generally described this invention, further understanding can be obtained by reference to certain specific examples which are provided herein for the purpose of illustration only and are not intended to be limiting. In the descriptions in the following examples, the numbers represent weight ratios in parts, unless otherwise specified.

### Preparation of Resin Particle Dispersion

Charge a reaction vessel equipped with a stirrer and a thermometer with 683 parts of water, 11 parts of a sodium salt of a sulfate of ethylene oxide adduct of methacrylic acid (ELEMINOL RS-30 from Sanyo Chemical Industries, Ltd.), 83 parts of styrene, 83 parts of methacrylic acid, 110 parts of butyl acrylate, and 1 part of ammonium persulfate. Agitate the mixture for 15 minutes at a revolution of 400 rpm. Thus, an emulsion that is white is prepared. Heat the emulsion to 75° C. and subject it to a reaction for 5 hours. Further add 30 parts of a 1% aqueous solution of ammonium persulfate to the emulsion, and age the mixture for 5 hours at 75° C. Thus, a resin particle dispersion 1 that is an aqueous dispersion of a vinyl resin (i.e., a copolymer of styrene, methacrylic acid, butyl acrylate, and a sodium salt of a sulfate of ethylene oxide adduct of methacrylic acid) is prepared. Subject the resin particle dispersion 1 to a measurement by a laser diffraction particle size distribution analyzer LA-920 (from Horiba, Ltd.). The weight average particle diameter of the resin particle dispersion 1 is 105 nm. Dry out a part of the resin particle dispersion 1 to isolate the resin therefrom. The isolated resin has a glass transition temperature (Tg) of 59° C. and a weight average molecular weight of 150,000.

### Preparation of Aqueous Phase

Mix 990 parts of water, 83 parts of the resin particle dispersion 1, 37 parts of a 48.5% aqueous solution of dodecyl diphenyl ether sodium disulfonate (ELEMINOL MON-7 from Sanyo Chemical Industries, Ltd.), and 90 parts of ethyl acetate. Thus, an aqueous phase 1 that is a milky whitish liquid is prepared.

### Preparation of Low-Molecular-Weight Polyester (Crystalline Polyester)

Charge a reaction vessel equipped with a condenser, a stirrer, and a nitrogen inlet pipe with 229 parts of ethylene oxide 2 mol adduct of bisphenol A, 529 parts of propylene oxide 3 mol adduct of bisphenol A, 208 parts of terephthalic acid, 46 parts of adipic acid, and 2 parts of dibutyltin oxide. Subject the mixture to a reaction for 8 hours at 230° C. under normal pressure and subsequent 5 hours under reduced pressures of 10 to 15 mmHg. After adding 44 parts of trimellitic anhydride, further subject the mixture to a reaction for 2 hours at 180° C. under normal pressure. Thus, a low-molecular-weight polyester 1 is prepared. The low-molecular-weight polyester 1 has a number average molecular weight of 2,500, a weight average molecular weight of 6,700, a glass transition temperature (Tg) of 43° C., and an acid value of 25 mgKOH/g.

### Preparation of Intermediate Polyester and Prepolymer

Charge a reaction vessel equipped with a condenser, a stirrer, and a nitrogen inlet pipe with 682 parts of ethylene oxide 2 mol adduct of bisphenol A, 81 parts of propylene oxide 2 mol adduct of bisphenol A, 283 parts of terephthalic acid, 22 parts of trimellitic anhydride, and 2 parts of dibutyltin oxide. Subject the mixture to a reaction for 8 hours at 230° C. under normal pressure and subsequent 5 hours under reduced pressures of 10 to 15 mmHg. Thus, an intermediate polyester 1 is prepared. The intermediate polyester 1 has a number average molecular weight of 2,100, a weight average molecular weight of 9,500, a glass transition temperature (Tg) of 55° C., an acid value of 0.5 mgKOH/g, and a hydroxyl value of 51 mgKOH/g.

Charge another reaction vessel equipped with a condenser, a stirrer, and a nitrogen inlet pipe with 410 parts of the intermediate polyester 1, 89 parts of isophorone diisocyanate, and 500 parts of ethyl acetate. Subject the mixture to a reaction for 5 hours at 100° C. Thus, a prepolymer 1 is prepared. The prepolymer 1 includes 1.53% of free isocyanates.

### Preparation of Ketimine Compound

Charge a reaction vessel equipped with a stirrer and a thermometer with 170 parts of isophoronediamine and 75 parts of methyl ethyl ketone. Subject the mixture to a reaction for 5 hours at 50° C. Thus, a ketimine compound I is prepared. The ketimine compound I has an amine value of 418 mgKOH/g.

### Preparation of Master Batch

Mix 35 parts of water, 40 parts of a phthalocyanine pigment FG7351 (from Toyo Ink Co., Ltd.), and 60 parts of a polyester resin RS301 (from Sanyo Chemical Industries, Ltd.) by a HENSCHEL MIXER (from Mitsui Mining and Smelting Co., Ltd.). Knead the resulting mixture by a double roll for 30 minutes at 150° C. Roll and cool the kneaded mixture and pulverize the rolled mixture into particles by a pulverizer. Thus, a master batch 1 is prepared.

### Preparation of Colorant Dispersion

Charge a reaction vessel equipped with a stirrer and a thermometer with 378 parts of the low-molecular-weight polyester 1, 110 parts of a carnauba wax, 22 parts of a charge controlling agent (a salicylic acid metal complex E-84 from Orient Chemical Industries Co., Ltd.), and 947 parts of ethyl acetate. Heat the mixture to 80° C. while agitating it, keep it at 80° C. for 5 hours, and cool it to 30° C. over a period of 1 hour. Further mix 500 parts of the master batch 1 and 500 parts of ethyl acetate in the mixture for 1 hour.

Thereafter, subject 1,324 parts of the resulting mixture to a dispersion treatment using a bead mill (ULTRAVISCOMILL (trademark) from Aimex Co., Ltd.) filled with 80% by volume of zirconia beads having a diameter of 0.5 mm, at a liquid feeding speed of 1 kg/hour, and a disc peripheral speed of 6 m/sec. Repeat this dispersing operation 3 times (3 passes) to disperse the wax and carbon black. After adding 1,324 parts of a 65% ethyl acetate solution of the low-molecular-weight polyester 1, further subject the resulting mixture to the above dispersing operation for 1 time (1 pass). Thus, a colorant dispersion 1 having a solid content of 50% (when measured at 130° C. for 30 minutes) is prepared.

### Emulsification

Mix 648 parts of the colorant dispersion 1, 154 parts of the prepolymer 1, and 6.6 parts of the ketimine compound 1 by a TK HOMOMIXER (from Primix Corporation) at a revolution of 5,000 rpm for 1 minute. Further mix 1,200 parts of the aqueous phase 1 therein by the TK HOMOMIXER at a revolution of 13,000 rpm for 20 minutes. Thus, an emulsion slurry 1 is obtained.

### Shape Control

Gradually add 3.15 parts of SEROGEN BS-H (from Dai-ichi Kogyo Seiyaku Co., Ltd.) to 75.6 parts of ion-exchange water being agitated by a TK HOMOMIXER (from Primix Corporation) at a revolution of 2,000 rpm, followed by agitation for 30 minutes at 20° C. Mix the resulting SEROGEN solution with 43.3 parts of a 48.5% aqueous solution of dodecyl diphenyl ether sodium disulfonate (ELEMINOL MON-7 from Sanyo Chemical Industries, Ltd.), followed by agitation for 5 minutes at 20° C. Mix 2,000 parts of the emulsion slurry 1 therein by a TK HOMOMIXER at a revolution of 2,000 rpm for 1 hour. Thus, a shape control slurry 1 is prepared.

### Solvent Removal

Heat the shape control slurry 1, contained in a vessel equipped with a stirrer and a thermometer, at 30° C. for 8 hours to remove the organic solvent and then heat at 45° C. for 4 hours to be aged. Thus, a dispersion slurry 1 is prepared.

### Washing and Drying

Filter 100 parts of the dispersion slurry 1 under reduced pressure and then mix with ion-exchange water by a TK HOMOMIXER at a revolution of 12,000 rpm for 10 minutes, followed by filtering. Thus a wet cake (1) is obtained. Mix the wet cake (1) with 100 parts of a 10% aqueous solution of sodium hydroxide by a TK HOMOMIXER at a revolution of 12,000 rpm for 30 minutes, followed by filtering under reduced pressure. Thus, a wet cake (2) is obtained. Mix the wet cake (2) with 100 parts of a 10% hydrochloric acid by a TK HOMOMIXER at a revolution of 12,000 rpm for 10 minutes, followed by filtering. Thus a wet cake (3) is obtained. Mix the wet cake (3) with 300 parts of ion-exchange water by a TK HOMOMIXER at a revolution of 12,000 rpm for 10 minutes, followed by filtering. Repeat this operation twice. Thus, a filtered cake 1 is obtained.

Dry the filtered cake 1 by a drier at 45° C. for 48 hours and then sieved it with a mesh having openings of 75 μm. Thus, a mother particle A is prepared.

### Preparation of Mother Particle B

Melt-knead the following materials by an air-cooled double roll mill for 15 minutes: 100 parts of a binder resin (i.e., a polyester resin primarily comprised of ethylene oxide adduct of bisphenol A and terephthalic acid, having a weight average molecular weight of 1.1×10⁴, a number average molecular weight of 3.9×10³, a viscosity (η) of 90 Pa·s at 140° C., and a glass transition temperature (Tg) of 69° C.), 20 parts of a high-melt-viscosity resin (i.e., a terpene-modified novolac resin, having a weight average molecular weight of 2,500, a softening point (Tm) of 165° C., and a viscosity (n) of 85,000 Pa·s at 140° C.), 5 parts of a carbon black (BPL from Cabot Corporation), 2 parts of a charge controlling agent (BONTRON E84 from Orient Chemical Industries Co., Ltd.), 5 parts of a low-molecular-weight polypropylene (VISCOL 660P from Sanyo Chemical industries, Ltd.), and 4 parts of a carnauba wax. Cool the kneaded mixture and pulverize the cooled mixture into fine particles by a jet mill. Classify the fine particles by size by a wind-power classifier. Thus, a mother particle B having a volume average particle diameter of 6 μM is prepared.

### Preparation of Toner Particle AA

Charge a 2,000-ml four-necked flask equipped with a thermometer, a nitrogen inlet pipe, and a stirrer with 100 g of the mother particle A and 886.9 g of distilled water. Replace the air in the flask with nitrogen gas. After adjusting the temperature of the reaction system to 25° C., add 13.2 g of tetramethoxysilane (including 2.4 g of silicon atoms) thereto while agitating the mixture. Subject the mixture to a reaction for 24 hours at 25° C. and subsequent 6 hours at 70° C. Thus, an aqueous solution of the mother particle A having an outer shell layer is prepared. The outer shell layer is a silica layer directly and chemically binding to the surface of the mother particle A and is formed by reacting a silicon compound with a surface of the mother particle A. Filter the aqueous solution under reduced pressure. Dry the filtered cake by a drier at 45° C. for 24 hours and then sieved with a mesh having openings of 75 μm. Thus, a toner particle AA is prepared.

### Preparation of Toner Particle AB

Repeat the procedure for preparing the toner particle AA except for replacing the tetramethoxysilane with 38.0 g of tetraethoxysilane (including 5.0 g of silicon atoms) and changing the reaction time at 25° C. for 120 hours. Thus, a toner particle AB is prepared.

### Preparation of Toner Particle AC

Charge a 2,000-ml four-necked flask equipped with a thermometer, a nitrogen inlet pipe, and a stirrer with 100 g of the mother particle A and 886.9 g of distilled water. Replace the air in the flask with nitrogen gas. After adjusting the temperature of the reaction system to 25° C., add 52.0 g of tetramethoxysilane (including 9.5 g of silicon atoms) thereto while agitating the mixture. Subject the mixture to a reaction for 24 hours at 25° C. and subsequent 6 hours at 70° C. Further add 0.08 g of dimethyl dimethoxysilane (including 0.015 g of silicon atoms) thereto while agitating the mixture. Subject the mixture to a reaction for 24 hours at 25° C. and subsequent 6 hours at 70° C. Filter the resulting aqueous solution under reduced pressure. Dry the filtered cake by a drier at 45° C. for 24 hours and then sieved with a mesh having openings of 75 μm. Thus, a toner particle AC is prepared.

### Preparation of Toner Particle BA

Repeat the procedure for preparing the toner particle AA except for replacing the mother particle A with the mother particle B. Thus, a toner particle BA is prepared.

### Preparation of Toner Particle BB

Repeat the procedure for preparing the toner particle AB except for replacing the mother particle A with the mother particle B. Thus, a toner particle BB is prepared.

### Preparation of Toner Particle BC

Repeat the procedure for preparing the toner particle AC except for replacing the mother particle A with the mother particle B. Thus, a toner particle BC is prepared.

### Preparation of Carrier Particle

Disperse 200 parts of a silicone resin solution (from Shin-Etsu Chemical Co., Ltd.) and 3 parts of a carbon black (from Cabot Corporation) in toluene to prepare a coating liquid. Apply the coating liquid to 2,500 parts of a ferrite core material by a fluidized-bed spraying method. Bake the ferrite core material thus covered with the coating liquid in an electric furnace for 2 hours at 300° C. Sieve the resulting bulk carrier with a 63-μm mesh and subsequently with a 45-μm mesh. Thus, a carrier particle having an average particle diameter of 35 μm is prepared.

### Example 1

Mix 100 parts of the toner particle AA and 0.75 parts of an isobutyl-treated hydrophobized rutile-type titanium oxide having an average particle diameter of 15 nm by a HENSCHEL MIXER while setting the peripheral speed of its agitation blades to 35 msec.

Further, mix 0.8 parts of a hexamethyl-disilazane-treated hydrophobized silica having an average particle diameter of 8 nm therein by a HENSCHEL MIXER while setting the peripheral speed of its agitation blades to 35 msec.

Mix 7 parts of the toner particle AA treated as above and 93 parts of the carrier particle. Thus, a developer AA having a toner concentration of 7% is prepared.

### Example 2

Repeat the procedure in Example 1 except for replacing the toner particle AA with the toner particle AB. Thus, a developer AB is prepared.

### Example 3

Repeat the procedure in Example 1 except for replacing the toner particle AA with the toner particle AC. Thus, a developer AC is prepared.

### Example 4

Repeat the procedure in Example 1 except for replacing the toner particle AA with the toner particle BA. Thus, a developer BA is prepared.

### Example 5

Repeat the procedure in Example 1 except for replacing the toner particle AA with the toner particle BB. Thus, a developer BB is prepared. Example 6 Repeat the procedure in Example 1 except for replacing the toner particle AA with the toner particle BC. Thus, a developer BC is prepared.

### Comparative Example 1

Repeat the procedure in Example 1 except for replacing the toner particle AA with the toner particle A. Thus, a developer A is prepared.

### Comparative Example 2

Repeat the procedure in Example 1 except for replacing the toner particle AA with the toner particle B. Thus, a developer B is prepared.

An image forming apparatus used for the following evaluations includes a photoreceptor that bears an electrostatic latent image; a charging roller disposed in proximity to or in contact with the photoreceptor that uniformly charges the photoreceptor; an irradiator that irradiates the photoreceptor with light to form an electrostatic latent image thereon; a developing device that develops the electrostatic latent image into a toner image with the developer; a transfer belt that transfers the toner image from the photoreceptor onto a transfer paper; a cleaner that removes residual toner particles remaining on the photoreceptor; a neutralization lamp that removes residual charges remaining on the photoreceptor; and an optical sensor that controls the voltage supplied from the charging roller and the toner concentration in the developer. The developing device is supplied with the toner from a toner supply device through a toner supply opening.

An image forming operation is as follows. First, the photoreceptor starts rotating counterclockwise. The photoreceptor is neutralized by light so as to have an average surface potential of 0 to −150 V. The photoreceptor is then charged by the charger so as to have a surface potential of about −1,000 V. The photoreceptor is further irradiated with light emitted from the irradiator so that the irradiated area (i.e., image area) has a surface potential of 0 to −200V. The developing device supplies the toner to the image area from the developing sleeve. A paper feed part feeds a sheet of the transfer paper onto the transfer belt so that a leading edge of the sheet coincides with a leading edge of the toner image having been conveyed by rotation of the photoreceptor. As a result, the toner image is transferred from the photoreceptor onto the sheet on the transfer belt. The toner image is fixed on the sheet upon application of heat and pressure in a fixer. The sheet having the fixed toner image is discharged from the image forming apparatus. Residual toner particles remaining on the photoreceptor are removed by a cleaning blade in the cleaner. Subsequently, residual charges remaining on the photoreceptor are neutralized by the neutralization lamp. Thus, the photoreceptor gets ready for a next image forming operation.

Subject the above-prepared toners and developers to the following evaluations. The evaluation results are shown in Table 2.

### (1) Image Quality

Image quality is comprehensively evaluated from two points: the degrees of defective transfer and background fouling. To determine the degree of defective transfer, continuously produce an image on 5,000 sheets of paper, then produce a black solid image, and visually observe the black solid image. To determine the degree of background fouling, continuously produce an image on 5,000 sheets of paper, then develop a white solid image, and quantify toner particles present on the photoreceptor during the development of the white solid image. Specifically, interrupt the development of the white solid image and transfer toner particles present on the photoreceptor onto SCOTCH tape (from Sumitomo 3M). Subject the SCOTCH tape having the toner particles to a measurement of image density by a spectrodensitometer (from X-Rite). When the image density difference between a blank SCOTCH tape is less than 0.30, the degree of background fouling is regarded as being low (good). When the image density difference between a blank SCOTCH tape is 0.30 or more, the degree of background fouling is regarded as being high (poor). Comprehensive image quality is graded into three ranks: A (good), B (acceptable), and C (poor).

### (2) Image Granularity and Sharpness

To determine image granularity and sharpness, produce a monochrome photographic image with a digital full-color copier (IMAGIO COLOR 2800 from Ricoh Co., Ltd.) and visually observe the image. Image granularity and sharpness is graded into four ranks: A+ (similar to offset printing quality), A (slightly worse than offset printing quality), B (considerably worse than offset printing quality), and C (similar to ordinary electrophotographic image quality, very poor).

### (3) Fixability

Produce images by a modified copier MF 2200 (from Ricoh Co., Ltd.) employing a TEFLON® fixing roller, in which the fixing part is modified, on sheets of paper (TYPE 6200 from Ricoh Co., Ltd.) while varying the fixing temperature. Determine the minimum fixable temperature below which cold offset occurs. Set the linear speed of paper feeding to 120 to 150 mm/sec, the surface pressure to 1.2 Kgf/cm², and the nip width to 3 mm. Fixability (cold offset resistance) is graded into the following five ranks.

A+: The minimum fixable temperature is less than 140° C.

A: The minimum fixable temperature is not less than 140 and less than 150° C.

B+: The minimum fixable temperature is not less than 150 and less than 160° C.

B: The minimum fixable temperature is not less than 160 and less than 170° C.

C: The minimum fixable temperature is not less than 170° C.

### (4) Heat-Resistant Storage Stability

Store each toner at 50° C. for 8 hours. Sieve the toner with a 42 mesh for 2 minutes and determine the residual ratio of toner particles remaining on the mesh. The smaller the residual ratio, the better the heat-resistant storage stability. Heat-resistant storage stability is graded into four ranks.

A+: The residual ratio is less than 10%.

A: The residual ratio is not less than 10% and less than 20%.

B: The residual ratio is not less than 20% and less than 30%.

C: The residual ratio is not less than 30%.

### (5) Comprehensive Evaluation

Comprehensive evaluation is based on the number of B and C ranks each developer or toner is given in the above evaluation (1) to (4).

A: The number of B and C ranks is 0.

B: The number of B and C ranks is 1.

C: The number of B and C ranks is 2 or more.

The evaluation results are shown in Table 1.

TABLE 1

| | | (2) Image | | (4) Heat- | |
|---|---|---|---|---|---|
| | (1) | Granularity | | resistant | (5) |
| Toner | Image | and | (3) | Storage | Comprehensive |
| Particle | Quality | Sharpness | Fixability | Stability | Evaluation |
| AA | A | A | A | A | A |
| AB | A | A | A | A | A |
| AC | A | A+ | B+ | A+ | A |
| BA | A | A | A | A | A |
| BB | A | A+ | A | A+ | A |
| BC | A | A+ | B+ | A+ | A |
| A | A | A | A | B | B |
| B | B | B | A | A | C |

Additional modifications and variations in accordance with further embodiments of the present invention are possible in light of the above teachings. It is therefore to be understood that within the scope of the appended claims the invention may be practiced other than as specifically described herein.

What is claimed is:

1. A toner particle, comprising:
a mother particle, the mother particle including a binder resin and a colorant; and
an outer shell layer, the outer shell layer formed of a reaction product of a silicon compound chemically binding to a surface of the mother particle.

2. The toner particle according to claim 1, wherein the silicon compound is tetraalkoxysilane.

3. The toner particle according to claim 1, wherein a content of silicon atoms in the reaction product of the silicon compound is within a range of 0.5 to 30 parts by weight based on 100 parts by weight of the mother particle.

4. The toner particle according to claim 1, further comprising an external additive on the outer shell layer.

5. A one-component developer, comprising:
the toner particle according to claim 1; and
no carrier particle.

6. A two-component developer, comprising
the toner particle according to claim 1; and
a carrier particle.

7. An image forming method, comprising:
charging a surface of an image bearing member;
developing an electrostatic latent image formed on the charged surface of the image bearing member into a toner image with the toner according to claim 1;
transferring the toner image from the image bearing member onto an image support; and
fixing the toner image on the image support by applying heat and pressure to the toner image with a roller-shaped or belt-shaped fixing member.

8. A toner particle, comprising:
a mother particle, the mother particle including a binder resin and a colorant; and
an outer shell layer, the outer shell layer formed of a silica compound chemically binding to a surface of the mother particle.

9. The toner particle according to claim 8, wherein a content of silicon atoms in the silica compound is within a range of 0.5 to 30 parts by weight based on 100 parts by weight of the mother particle.

10. The toner particle according to claim 8, further comprising an external additive on the outer shell layer.

11. A one-component developer, comprising:
the toner particle according to claim 8; and
no carrier particle.

12. A two-component developer, comprising
the toner particle according to claim 8; and
a carrier particle.

13. An image forming method, comprising:
charging a surface of an image bearing member;
developing an electrostatic latent image formed on the charged surface of the image bearing member into a toner image with the toner according to claim 8;
transferring the toner image from the image bearing member onto an image support; and
fixing the toner image on the image support by applying heat and pressure to the toner image with a roller-shaped or belt-shaped fixing member.
